(19) United States
(12) Patent Application Publication
(10) Pub. No.: US 2019/0377171 A1
(43) Pub. Date: Dec. 12, 2019

(54) Analog-Digital Hybrid Firearm Scope

(71) Applicant: TrackingPoint, Inc., Pflugerville, TX (US)

(72) Inventors: Douglas Richard Hammond, Pflugerville, TX (US); John F. McHale, Austin, TX (US)

(73) Assignee: TrackingPoint, Inc., Pflugerville, TX (US)

(21) Appl. No.: 16/169,957

(22) Filed: Oct. 24, 2018

Related U.S. Application Data
(63) Continuation-in-part of application No. 16/006,531, filed on Jun. 12, 2018.

(51) Int. Cl. G02B 23/12; F41G 1/38; F41G 1/473; F41G 1/36; F41G 3/06

(52) U.S. Cl. CPC G02B 23/12; F41G 1/38; F41G 3/065; F41G 1/36; F41G 1/473

(57) ABSTRACT

In some embodiments, an optical scope includes a direct-view optics assembly including an objective lens and a viewing lens. The direct-view optics assembly may be configured to direct and focus light from a view area received by the objective lens toward the viewing lens. The optical scope may further include a selectable element accessible by a user to select one of a direct-view mode and a digital-view mode and a switchable circuit element configured to selectively interrupt a light path between the objective lens and the viewing lens in response to selection of the digital-view mode.

### CROSS-REFERENCE TO RELATED APPLICATION(S)

The present disclosure is a continuation-in-part of and claims priority to U.S. patent application Ser. No. 16/006,531 filed on Jun. 12, 2018 and entitled “Analog-Digital Hybrid Firearm Scope,” which is incorporated herein by reference in its entirety.

### FIELD

The present disclosure is generally related to a firearm scope including a switchable element, and more particularly to a firearm scope that includes a selectable, switchable digital display element.

### BACKGROUND

Analog firearm scopes have been used for many years. Some analog firearm scopes provide adjustable zoom and optionally user-selectable features that allow the user to manually adjust the reticle alignment for range and wind.

Digital firearm scope solutions exist that can automate some adjustments related to a ballistic solution for a particular target and offer additional advanced features. Such solutions may rely on a battery based power supply.

### SUMMARY

Embodiments of an optical firearm scope are described below that can provide an analog direct-view path with an etched glass or wire reticle for use in all conditions, including battery power loss. The scope may include a digital imaging path configured to direct light to a high-resolution color complementary metal-oxide semiconductor (CMOS) sensor to capture light associated with a view area or may include a switchable circuit element, such as a sensor, that can be switched into and out of the direct-view path. In some embodiments, a switchable circuit element can be selectively actuated into the analog direct-view path to switch between a direct-view and a digital view.

In some embodiments, an optical firearm scope may include a light path including an etched glass reticle and configured to receive light associated with a view area. The optical firearm scope may further include at least one optical sensor configured to capture image data associated with a view area. The optical firearm scope can include a circuit element that can be selectively actuated into the light path to provide digital functionality. In one aspect, the circuit element may include the optical sensor. In another aspect, the circuit element may include a microdisplay configured to display image data to provide a digital display. In a first mode, the optical sensors and the microdisplay may be in a low-power or power off mode with the switchable circuit element outside of the light path, and in a second mode, the optical sensors and the microdisplay may be in an operating power mode with the switchable circuit element in the light path.

In some embodiments, an optical scope includes a direct-view optics assembly including an objective lens and a viewing lens. The direct-view optics assembly may be configured to direct and focus light from a view area received by the objective lens toward the viewing lens. The optical scope may further include a selectable element accessible by a user to select one of a direct-view mode and a digital-view mode and a switchable circuit element configured to selectively interrupt a light path between the objective lens and the viewing lens in response to selection of the digital-view mode.

In other embodiments, a method can include, in a first mode, providing light received at an objective lens of an optical scope through a first focal plane including a reticle to a viewing lens of the optical scope. The method may further include receiving an input corresponding to a change of position of a lever of the optical scope and, in a second mode, coupling a switchable circuit element into the optical path to capture optical data and provide image data viewable from the viewing lens.

In still other embodiments, an optical scope may include control circuitry, a direct-view optics assembly, and a switchable circuit element. The direct-view optics assembly may include an objective lens and a viewing lens, and may be configured to direct and focus light received by the objective lens toward the viewing lens. The switchable circuit element may be coupled to the control circuitry and configured to selectively interrupt a light path between the objective lens and the viewing lens to capture and present image data to the viewing lens. In one aspect, the switchable circuit element may include an optical sensor. In another aspect, the switchable circuit element may include a display.

### BRIEF DESCRIPTION OF THE DRAWINGS

FIG. 1A depicts a side view of a firearm system including a scope with a switchable circuit element, in accordance with certain embodiments of the present disclosure.

FIG. 1B depicts an isometric view of the firearm system of FIG. 1A.

FIG. 2A depicts an isometric view of the scope of FIGS. 1A-1B.

FIG. 2B depicts a front view of the scope of FIGS. 1A-2A.

FIG. 3 depicts an isometric view of a firearm system including second embodiment of a scope including a switchable circuit element, in accordance with certain embodiments of the present disclosure.

FIG. 4A depicts a switchable circuit element including a pivot configured to enable pivot-based switching, in accordance with certain embodiments of the present disclosure.

FIG. 4B depicts a switchable circuit element configured to provide a translation-based switching, in accordance with certain embodiments of the present disclosure.

FIG. 5A depicts a switchable circuit element including a stationary display and a movable mirror element configured to provide pivot-based switching, in accordance with certain embodiments of the present disclosure.

FIG. 5B depicts a switchable circuit element including a stationary display and a movable mirror element configured to provide translation-based switching, in accordance with certain embodiments of the present disclosure.

FIGS. 6A and 6B depict switchable circuit elements configured to provide electrically controlled switching, in accordance with certain embodiments of the present disclosure.

FIG. 7 depicts a diagram of components of a scope of FIGS. 1A-2B including a microdisplay that can be selectively switched into an optical path, in accordance with certain embodiments of the present disclosure.

FIG. 8 depicts a diagram of components of a scope of FIGS. 1A-2B including a selectively transmissive microdisplay, in accordance with certain embodiments of the present disclosure.

FIG. 9 depicts a diagram of components of a scope of FIG. 3 including a splitter configured to direct light from the optical path toward a sensor circuit, in accordance with certain embodiments of the present disclosure.

FIG. 10 depicts a diagram of components of a scope of FIGS. 1A-3 including a switchable element including a switchable prism, in accordance with certain embodiments of the present disclosure.

FIG. 11 depicts a block diagram of a scope of any of FIGS. 1A-10 including circuitry configured to control operation of the switchable display element, in accordance with certain embodiments of the present disclosure.

FIG. 12 depicts a block diagram of components of a scope including an image rotating prism and a switchable display element, in accordance with certain embodiments of the present disclosure.

FIG. 13 depicts an isometric view of a battery pack that can be incorporated within the firearm of FIGS. 1A-3, within the scope of FIGS. 3-12, or any combination thereof.

FIG. 14 depicts a flow diagram of a method of selectively actuating a circuit element into alignment with a light path, in accordance with certain embodiments of the present disclosure.

FIG. 15 depicts a flow diagram of a method of selectively controlling a circuit element, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

Embodiments of a firearm system, scopes, apparatuses, and devices are described below that include direct-view optics configured to focus light from a view area toward a viewing lens. Further, the firearm system, scopes, apparatuses, and devices include a switchable circuit element that can be selectively enabled to provide a digital image to the viewing lens.

In some embodiments, the firearm system, scopes, apparatuses, and devices described below may include a fire control system including a control circuit within the scope that is coupled to a trigger assembly of the firearm. The fire control system may be configured to selectively control timing of discharge of the firearm to ensure that the ballistic strikes its intended target. In some embodiments, the fire control system may be enabled independently of the display, allowing the use of the fire control functionality in conjunction with the direct-view optics. In other embodiments, the fire control system may be enabled in conjunction with activation of the switchable circuit element, which may enable an optical sensor to capture images associated with the view area, a processor configured to determine optical data from the images, and a display to present the optical data to the viewing lens.

In other embodiments, the fire control system may be disabled and the switchable circuit element may be enabled, such that the trigger assembly functions as a traditional firearm with a digital optical display. In still other embodiments, the display and the fire control system may be deactivated and powered off or transitioned to a low-power mode and the user may utilize the direct-view optics. Other embodiments are also possible.

In some embodiments, a goal of the fire control system is to improve the probability of a hit when the weapon system is discharged by aiding and augmenting the shooter's capabilities. Further, embodiments of the present disclosure augment the fire control system by providing both analog and digital viewing functionality in response to user selections.

Embodiments of systems, methods, and devices are described below that includes an optical device that can be configured to provide an analog, direct-view functionality in a first mode, and a digital-view functionality in a second mode. In one possible embodiment, the optical device may include a first (direct-view) light path configured to focus light from a view area toward a viewing lens and may include a second (digital-view) light path configured to direct light from the view area toward a sensor. In the second mode, the optical device may the determine image data using the sensor, and may present the image data to the viewing lens via a display.

In some embodiments, the firearm system may include a scope including a direct-view path with an etched glass reticle for use in all conditions, including battery power loss. Additionally, the scope may include a digital image processing pipeline, integrated laser rangefinder (LRF), environmental sensors (temperature, barometric pressure, humidity, and other environmental sensors), an Inertial Measurement Unit (IMU) including accelerometers and directional sensors (elevation angle, cant angle, cardinal direction), other sensors, or any combination thereof. The firearm system may combine the sensor measurements with pre-configured ballistics inputs for the ammunition and firearm parameters to determine a ballistic firing solution corresponding to a predicted impact point of a discharged ballistic. The sensors may be sampled and the firing solution may be recalculated at the sampling rate of the sensors. Other embodiments are also possible.

It should be understood that the digital circuitry included in the optical devices or scopes disclosed herein may be configured to enable a range of digital functions, including, but not limited to fire control, zoom, night vision, target acquisition, target tracking, ranging, ballistics solutions calculations, and other functionality. In some embodiments, during direct-view mode operations, fire control, target acquisition, target tracking, ranging, ballistics solutions calculations, other functionality, or any combination thereof may be active and enabled without impacting the direct-view operations.

In a particular example, a firearm system may include a trigger assembly and an optical scope coupled to the trigger assembly. The optical scope may be configured to determine a ballistic solution for a selected target and to control discharge of the firearm through control signals provided to the trigger assembly to prevent discharge of the firearm until an aim point of the firearm (as determined by a processor based on signals from one or more sensors) is aligned to the selected target. Other embodiments are also possible.

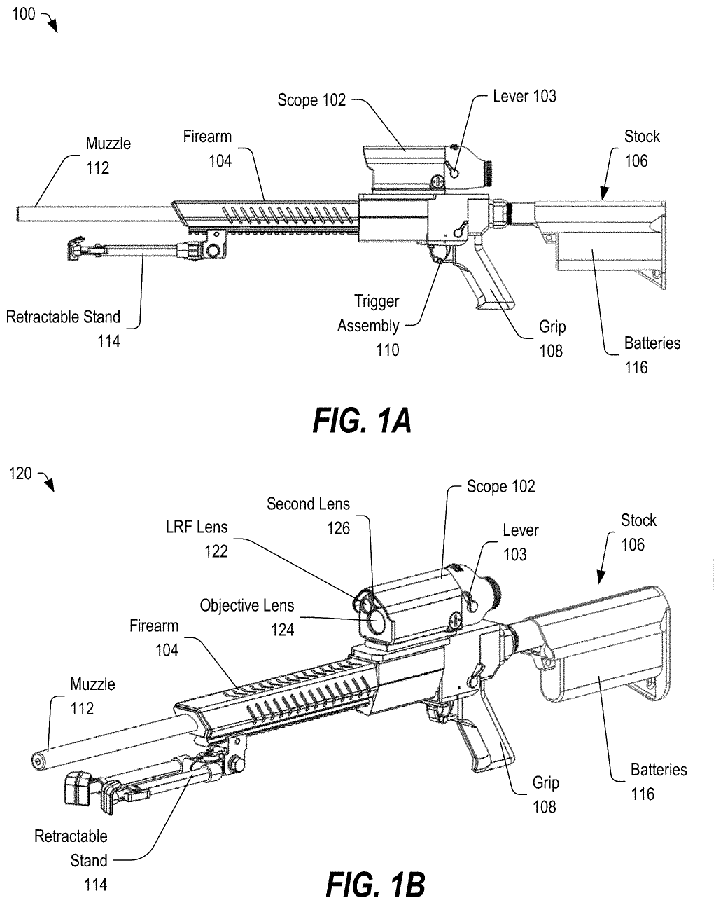

FIG. 1A depicts a side view of a firearm system 100 including a scope 102 with a switchable circuit element, in accordance with certain embodiments of the present disclosure. The firearm system 100 may include a firearm 104 coupled to the scope 102. The firearm 104 may include a stock 106, a grip 108, a trigger assembly 110, and a muzzle 112. In some embodiments, the firearm 104 may include a retractable stand 114. Further, in some embodiments, the stock 106 may define a housing sized to secure a power supply, such as batteries 116.

In the illustrated example, the scope 102 may include a direct-view optic (DVO) with the added capabilities of a digital optic. The scope 102 may include a direct-view path with a traditional etched glass reticle for use in all conditions, including battery power loss. Additionally, the scope 102 may include a digital imaging pipeline, integrated laser rangefinder (LRF), environmental sensors (temperature, barometric pressure, humidity, and other environmental sensors), and an Inertial Measurement Unit (IMU) including accelerometers and directional sensors (elevation angle, cant angle, cardinal direction), imaging sensors (such as a complementary metal oxide semiconductor (CMOS) image sensor), other sensors, or any combination thereof. The scope 102 may include a lever 103, which may be accessed by the user to transition the operating mode of the scope 102 between the direct-view path mode in which light from the view area is focused toward the viewing lens of the scope 102 and the digital imaging pipeline mode in which light from the view area are captured by an optical sensor and at least a portion of the captured optical data is presented to the viewing lens of the scope 102 via a display. The lever 103 may cause the display, a mirror, a prism, a sensor, or another object to move into or out of the light path to switch between a digital display mode and a direct-view mode. In some embodiments, the lever 103 may cause a control circuit to provide an electrical signal to one of a mirror, a prism, and a display device to alter the reflectivity of a surface in order to selectively switch the display element into the light path.

In some operating modes, the sensor measurements may be combined by a processor of the scope 102 with pre-configured ballistics inputs for the ammunition and firearm parameters to determine a ballistic firing solution. In a particular embodiment, the sensors can be sampled and the firing solution recalculated at the sampling rate of the sensors.

FIG. 1B depicts an isometric view 120 of the firearm system 100 of FIG. 1A. In the illustrated example, a front portion of the scope 102 is visible, showing three lenses. In this example, the scope 102 may include a laser rangefinder (LRF) lens 122 through which a laser rangefinder circuit may emit a pulsed collimated beam and optionally receive reflected light that can be used to determine a range to a target. The scope 102 may also include an objective lens 124 configured to receive light associated with the view area and associated with an analog path. Further, the scope 102 may include a second lens 126, which may be configured to receive reflected light from the LRF beam, infrared light, or optionally ambient light associated with a view area.

In one embodiment, the scope 102 may be configured to provide both a direct-view functionality and a digital-view functionality, and may include a lever 103, which may be accessed by a user to switch between the direct-view mode and the digital-view mode. In an alternative embodiment, the lever 103 may be replaced with a switch, a button, or another user-selectable element accessible by the user to switch between operating modes.

In one possible embodiment, the scope 102 may include a first light path including lenses configured to focus light from the view area toward a viewing lens and a second light path including at least one optical sensor configured to capture images of the view area. In the direct-view mode, the optical sensor may be disabled. In the digital-view mode, the optical sensor may capture optical data, which may be presented to the viewing lens via a display.

In another possible embodiment, the scope 102 may include a shared light path. In this example, a circuit element may be switched into or out of the light path according to the viewing mode. The circuit element may include a sensor, a display, another circuit component, or any combination thereof.

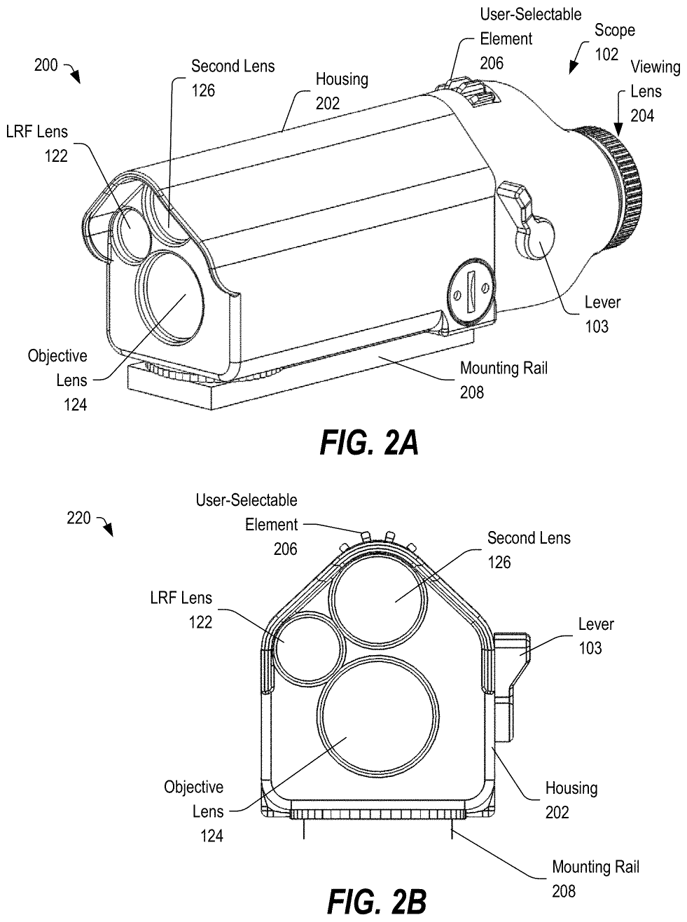

FIG. 2A depicts an isometric view 200 of the scope 102 of FIGS. 1A-1B. The scope 102 may include a housing 202 defining an enclosure sized to secure an optics assembly including a plurality of lenses configured to focus and optionally magnify light from a view area. The housing 202 may be coupled to a mounting rail 208, which may be configured to couple to a firearm 104.

The scope 102 may include a viewing lens 204 through which a user may view focused light from the view area, which may be presented by the DVO assembly, by a switchable display element, or both. The scope 102 may further include user-selectable elements including a wheel 206, which can be turned to adjust focus and optionally magnification or zoom settings of the DVO assembly. The scope 102 may also include a user-selectable locking lever or switch 103 that can be accessed by a user to switch between operating modes of the scope 102 and optionally the firearm 104.

In some embodiments, the scope 102 may include a direct-view mode in which circuitry, including a switchable circuit element within the scope 102, is powered off or configured in a low-power state while light from the view area of the scope 102 is focused toward the viewing lens 204 through the DVO assembly. The scope 102 may also include a digital optical mode in which the circuitry and the display element of the scope 102 are powered on and the switchable circuit element (sensor, display, or both) is switched into the visual optical path of the viewing lens 204 to provide a digital display including optical data associated with the view area. The scope 102 may also include a fire-control mode in which timing of the discharge of the firearm 104 may be controlled via electrical signals provided by the scope 102 to the trigger assembly 110. In an example, in the fire-control mode, the scope 102 may process sensor data, including motion and orientation data, to determine a current aim point of a firearm 104 relative to a ballistic solution for a selected target. The ballistic solution may represent a calculation of the expected flight of a ballistic if fired from the weapon and may include the measured distance to the target from the laser rangefinder (LRF), measured environmental data (temperature, humidity, barometric pressure), measured directional data from the IMU sensors, and measured or manual external wind input. In the fire-control mode, the scope 102 may control timing of the discharge of the firearm 104, in response to a trigger pull, to prevent discharge until the aim point of the firearm 104 is aligned with the selected target according the ballistic solution (within a selected threshold).

In some embodiments, the scope 102 may include a digital display mode with fire-control in which the digital display is active and is configured to present images to the viewing lens 204. The scope 102 may further include a digital display mode without fire-control in which the digital display provides images to the viewing lens 204 and in which the trigger assembly 110 is not controlled by the scope 102 and is responsive to a trigger pull. The scope 102 may also include a direct-view hybrid mode in which the digital display is inactive, but the fire-control is active while the light from the view area is provided to the viewing lens 204 via the DVO assembly. Other embodiments are also possible.

FIG. 2B depicts a front view 220 of the scope 102 of FIGS. 1A-2A. In this example, the scope 102 may include an LRF lens 122, through which a pulsed collimated beam may be emitted by a LRF circuit toward the view area and through which reflected light may be received by LRF sensors. The LRF circuit may be configured to determine a range to a target within the view area.

The scope 102 may further include an objective lens 124 associated with an analog path. The objective lens 124 may be aligned with a DVO assembly including a plurality of lenses, which may be configured to focus light from the view area toward the viewing lens 204. The scope 102 may also include a second lens 126 associated with the circuitry of the scope 102 and configured to direct light from the view area toward one or more optical sensors of the circuitry. In one embodiment, the second lens 126 may be configured to receive ambient light from the view area. In another embodiment, the second lens 126 may be configured to receive infrared light from the view area. In still another embodiment, the second lens 126 may be configured to receive reflected light from the view area.

In some embodiments, the housing may be approximately 7 inches long, 2.75 inches tall, and 2.5 inches wide. In some embodiments, the scope 102 may weigh approximately 2.9 pounds. In other embodiments, composite materials or lightweight lenses can be used to reduce the weight.

In one possible embodiment, the scope 102 may include 30 mm direct-view aperture 124 and a 22 mm digital camera objective aperture 126. The aperture 122 may be a 15 mm laser rangefinder transmit aperture, which may be separated from the direct-view path. In some embodiments, an additional objective, such as a thermal objective, can be added.

The scope 102 may include an adjustable ocular lens assembly (viewing lens 204) to allow the shooter to focus the reticle and display element to their eye. The ocular adjustment would typically be +4 to −4 diopters. Further, a manual scene focus knob can be included to optimally focus the camera objective on the target. A base adjustment mechanism for zeroing the scope 102 may be included. One possible advantage of the base adjustment method is that the direct-view reticle, LRF transmit, LRF receive, and digital reticle can all be co-aligned on an optical alignment fixture at the time of manufacture and be permanently fixed into place. The co-aligned optics assembly can then be zeroed on the firearm 104 and no other adjustments are necessary. Other embodiments of adjusting and zeroing the direct-view and digital paths are also possible.

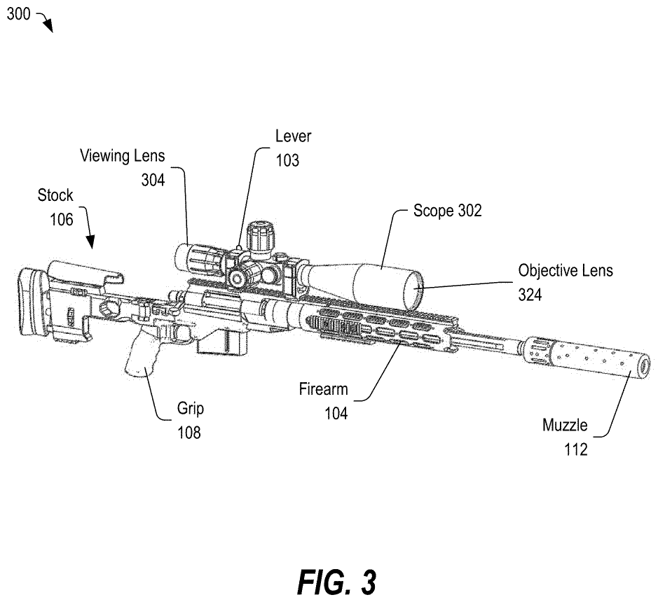

It should be appreciated that the embodiments of FIGS. 1A-2B represent possible examples of a scope 102, which has three lenses. In other embodiments, one or two of the lenses may be eliminated, and the scope 102 may include a single lens through which the LRF beam may be transmitted, and the light from the view area as well as the reflected light from the LRF beam may be received. One possible example is described below with respect to FIG. 3.

FIG. 3 depicts an isometric view of a firearm system 300 including a second embodiment of a scope 302 including a switchable circuit element, in accordance with certain embodiments of the present disclosure. The firearm system 300 may include all of the elements of the firearm system 100 of FIG. 1, except that that the scope 102 may be replaced with the scope 302 having an objective lens 324 and including a viewing lens 304. Other lenses shown with respect to FIGS. 1A-2B may be omitted.

In the illustrated example, the scope 302 may include a direct-view light path, circuitry including optical sensors and including a display element, a LRF circuit, and one or more light splitters configured to direct LRF frequencies toward the LRF circuit. A portion of the light captured by the objective lens 324 maybe directed to the optical sensors of the circuitry, and the remainder of the light allowed pass through to the viewing lens 304. In some embodiments, the switchable circuit element may be configured to move into and out of the light path between the objective lens 324 and the viewing lens 304. The scope 302 may be configured to enable the various modes described above, including a direct-view mode, a hybrid direct-view mode with direct-view optics and fire control functionality, a digital display mode with fire control functionality, and a digital display mode without fire control functionality.

In the illustrated example, the scope 302 may include a lever 103 that can be accessed by a user to manually move the display element, the optical sensor, or a mirror element into the light path; to electrically activate an element to move a digital display, a sensor, or both into the light path; to electrically activate an element to move a mirror, or a prism into the light path; to electrically activate a mirror, a prism, or a display to interrupt the light path; or any combination thereof. Other embodiments are also possible.

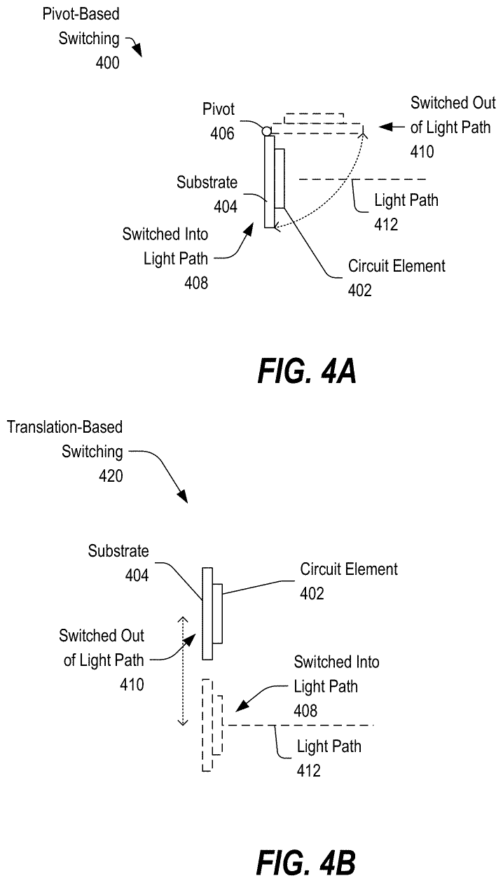

FIG. 4A depicts a switchable circuit element including a pivot 406 configured to enable pivot-based switching 400, in accordance with certain embodiments of the present disclosure. The switchable circuit element may include a substrate 404 coupled to the pivot (or hinge) 406 and configured to move about the pivot 406 to move into and out of a light path 412. A circuit element 402 may be coupled to the substrate 404, such that movement of the substrate 404 causes the circuit element 402 to be moved.

In the illustrated example, the circuit element 402 is switched into the light path at 408 and is switched out of the light path at 410. When the circuit element 402 is switched into the light path at 408, the circuit element 402 interrupts the light path. In one embodiment, the circuit element 402 may include an optical sensor, a microdisplay, or another circuit. In an example where the circuit element 402 includes a microdisplay, pivoting the microdisplay into the light path may allow the microdisplay to present digital display information to the viewing lens.

FIG. 4B depicts a switchable circuit element configured to provide a translation-based switching 420, in accordance with certain embodiments of the present disclosure. In this example, instead of pivoting or moving about the pivot 406 (as in FIG. 4A), the substrate 404 may be configured to move along a plane or along a path into and out of the light path 412 (as indicated by the dashed arrow).

In the examples of FIGS. 4A and 4B, the switchable circuit element may be moved manually, such as based on a mechanical coupling with the lever 103.

Alternatively, the switchable circuit element may be moved using an electrically controlled actuator, which may be controlled electrically in response to user interactions with the lever 103, a switch, another user-selectable element, or any combination thereof.

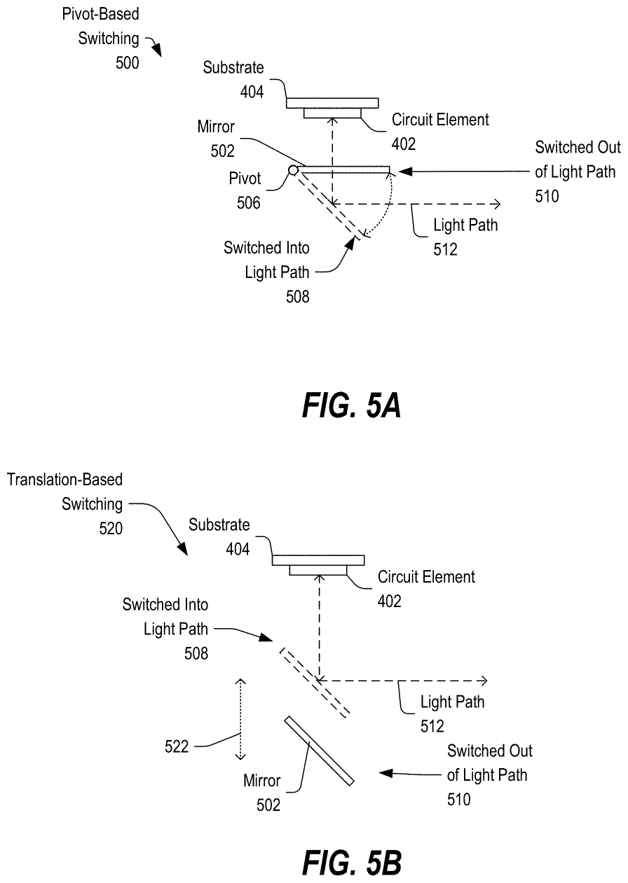

FIG. 5A depicts a switchable circuit element including a stationary circuit and a movable mirror element configured to provide pivot-based switching 500, in accordance with certain embodiments of the present disclosure. In this example, a switchable circuit element 402 may include a microdisplay or a sensor coupled to a substrate 404 that is fixed or stationary and configured to direct image or display information toward a movable mirror 502 or receive reflected light from the light path 512, depending on the implementation. The mirror 502 may be configured to move about a pivot 506 into the light path 512 (as indicated at 508) or out of the light path 512 (as indicated at 510).

FIG. 5B depicts a switchable circuit element including a stationary circuit and a movable mirror element configured to provide translation-based switching 520, in accordance with certain embodiments of the present disclosure. In this example, the circuit element 402 and substrate 404 may again remain stationary, while the mirror 502 is translated in the direction of arrow 522 into the light path 512 (as indicated at 508) and out from the light path 512 (as indicated at 510).

In the examples of FIGS. 5A and 5B, the switchable circuit element may be moved manually, such as based on a mechanical coupling with the lever 103. Alternatively, the switchable circuit element may be moved using an electrically controlled actuator, which may be controlled electrically in response to user interactions with the lever 103, a switch, another user-selectable element, or any combination thereof.

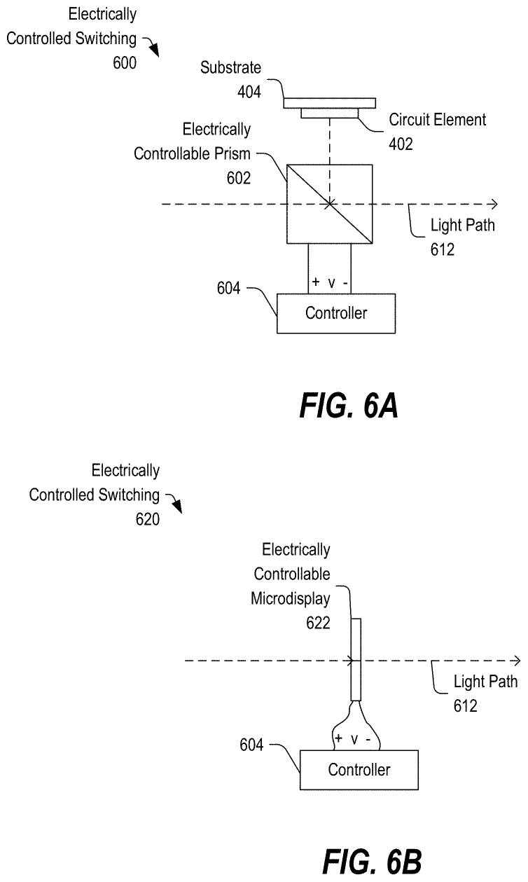

FIGS. 6A and 6B depict switchable display elements configured to provide electrically controlled switching 600, in accordance with certain embodiments of the present disclosure. In FIG. 6A, the circuit element 402 and the substrate 404 may be stationary, and an electrically controllable prism 602 (or mirror) may be electrically activated by signals received from a controller 604 to reflect light. The controller 604 may include a processor, sensors, and other circuitry. When the prism 602 is inactive, the prism 602 may allow light from the objective lens assembly to pass through toward the viewing lens along the light path. When the prism 602 is active, the prism 602 may reflect light from the microdisplay 402 into the light path 612 while blocking light from the objective lens. Other embodiments are also possible.

In an embodiment where the circuit element 402 includes a microdisplay, the electrically controllable prism 602 or mirror may reflect light from the microdisplay into the light path 612. In particular, the microdisplay may provide display data (such as image data from a view area, text, graphics, or any combination thereof) to the electrically controllable prism 602, which may direct the display data toward the viewing lens along the light path 612. In an embodiment where the circuit element 402 includes a sensor, the electrically controllable prism 602 may direct light from the light path 612 toward the sensor. Other embodiments are also possible.

In FIG. 6B, the electrically controls switching 620 may be implemented using an electrically controllable microdisplay 622. In some embodiments, the electrically controllable microdisplay 622 may be transparent when inactive to allow light from the object lens assembly to pass through toward the viewing lens along the light path 612. When the controller 604 provides electrical signals to activate the electrically controllable microdisplay 622, the electrically controllable microdisplay 622 may block light from the objective lens and display image data and other information received from a digital signal processing circuit, which may be part of the controller 604. Other embodiments are also possible.

It should be understood that, in FIGS. 6A and 6B, the reflectivity of the surface of the electrically controllable prism 602 or the electrically controllable microdisplay 622 may be controlled (activated or deactivated) by applied signals, such as a voltage, which may be provided by the controller 604. Other embodiments are also possible.

It should be appreciated that the examples provided in FIGS. 4A-6B represent different ways of switching a circuit element (such as a sensor, a display, or an electrically controllable device or element) into the light path, either physically via manual or electrically controlled movement of a mirror (or prism) or a display, or via electrical signals that alter the reflectivity of a surface of a prism, a display, or any combination thereof.

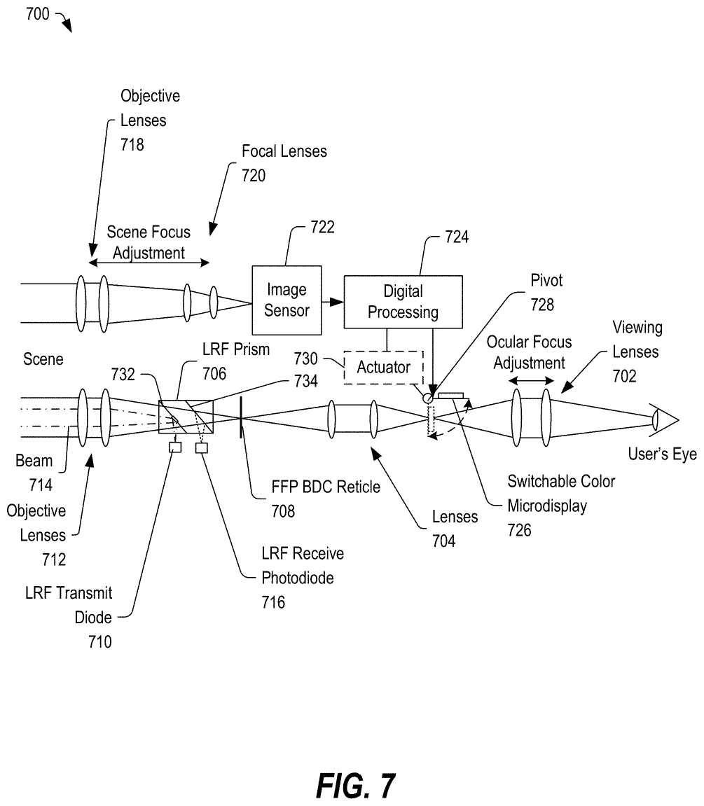

FIG. 7 depicts a diagram 700 of components of a scope 102 or 302 of FIGS. 1A-3 including a display element that can be selectively switched into an optical path, in accordance with certain embodiments of the present disclosure. While the diagram 700 shows two different optical paths, it should be appreciated that the two different optical paths may be received through the objective lenses 124 and 126 or through a single objective lens 324 with a light splitter providing the light to the image sensor 722 of the digital optical path. In alternative embodiments, additional digital light paths may be included by adding lenses and by including sensors responsive to other wavelength bands. In an example, one or more additional digital light paths may be included to provide, for example, a thermal path including associated thermal imaging sensors. Additional sensor possibilities could include long-wavelength infrared (LWIR) sensors, short-wavelength infrared (SWIR) sensors, medium wavelength infrared (MWIR) sensors, or visible-light digital sensors that are optimized for low-light imaging. These multiple digital paths could be used individually or fused and displayed to the user. Further, the paths could be used individually or fused for the purposed of display and optionally for target acquisition, selection, tracking, and fire control. Other embodiments are also possible.

The diagram 700 may include a viewing lens 702 through which a user may view light from the view area or images via a microdisplay 726. The scope 102 or 302 may include erector lenses 704, a reticle 708, and objective lenses 712. In operation, light from a scene or view area may be received by the objective lenses 712, which may focus the light toward the reticle 708 which may be located at the first focal plane of the scope 102 or 302. The light from the scene may be presented to erector lenses 704, which direct the light through a second focal plane toward the viewing lenses 702.

The pulsed LRF transmit beam 714 is directed to the objective lenses 712 by a partially mirrored prism surface 732 of the LRF prism 706. The LRF prism 706 may direct received reflected light associated with the beam 714 from the scene toward an LRF receive photodiode 716 by using a dichroic coated prism surface 734. The LRF circuitry may be configured to determine a range to an object based on the reflected light received by the LRF receive photodiode 716.

The scope 102 may include objective lenses 718 and focal lenses 720 as part of a digital light path. In the embodiment of the scope 302, the objective lenses 718 may be omitted and a beam splitter may be used to direct light from the objective lenses 712 either directly to an image sensor 722 or through focal lenses 720 to the image sensor 722.

In the illustrated example, the image sensor 722 may be a color complementary metal-oxide semiconductor (CMOS) image sensor. The image sensor 722 may include an output coupled to digital processing circuitry 724. The digital processing circuitry 724 may be configured to process image data from the image sensor 722 and to provide at least a portion of the image data to a switchable microdisplay 726, which may be a color display. The digital processing circuitry 724 may also be coupled to an actuator 730 that can be configured to move the microdisplay 726 into the optical path or out of the optical path about a pivot 728 to selectively present the user visual information associated with the scene via either the DVO assembly (i.e., lenses 712 and 704, and reticle 708) or the microdisplay 726.

The scope 102, as represented in the diagram 300, may provide a direct-view optical path (through lenses 712, 704, and 702) with a reticle 708 located in the first focal plane. In some embodiments, the direct-view optical path may provide a fixed 4× magnification with an objective diameter of 30 mm and a first focal plane ballistics drop compensating reticle. The laser rangefinder (LRF) transmit diode 710 and LRF receive photodiode 716 can be integrated into this direct-view aperture as shown in FIG. 7.

In some embodiments, a small mirrored portion of the transmit splitter surface 732 can couple the pulsed laser light from the LRF transmit diode 710 into the optical path. The receive splitter 734 may be a simple dichroic splitter that reflects the infrared LRF laser light and transmits the visible light. Alternatively, the LRF transmit path can include a third small aperture (lens 122 in FIGS. 1A-2B) instead of including the transmit splitter 732 in the direct-view path. The inclusion of the extra LRF lens 122 may have the advantage of not needing the small obscuration in the optical path, which may slightly reduce the direct-view light transmission and the LRF receive signal. In some embodiments, both the LRF transmit and receive can be separated into different optical paths (i.e. one lens path for the transmit diode and lenses, one path for the receive diode and lenses, and one path for the direct-view optical path). In embodiments where one or more LRF optical paths are separated from the direct-view path, the optical paths should remain mechanically coupled to ensure that alignment of the LRF transmit, LRF receive, and direct-view reticle 708 is maintained. This can be accomplished using a base adjustment mechanism that moves the scope housing 202 all optical paths together with respect to the firearm mounting rail 208. Other mechanical alignment and adjustment methods are also possible.

In the embodiments of FIGS. 1A-2B, a separate digital imaging light path may provide light to a high-resolution color CMOS image sensor 722. In some embodiments, the digital light path may have a 90 mm effective focal length, an aperture F/4, and a telecentric objective with a base image magnification of approximately 4×. In some embodiments, the digital zoom provided by the digital processing circuit 724 may provide a 6× multiplier; effectively making the objective a 4-24× digital optic.

The switchable color microdisplay 726 may be selectively incorporated in the second focal plane. In some embodiments, the microdisplay 726 may be an organic light-emitting diode (OLED) display with a resolution of 800×600 pixels or higher. The microdisplay 726 can be actuated by a locking lever or switch 103 accessible on the exterior of the scope 102 or 302, allowing the user to quickly switch between direct-view and digital-view mode. When the microdisplay 726 is switched out of the optical path, in a first mode, the digital image pipeline and other electronics may enter a low-power state or power-off state. This low-power state may allow for significant power savings while having a very short wake-up time when switched back into the optical path.

In some embodiments, the scope 102 or 302 may allow for both a direct-view and a digital day view. The digital image pipeline may also be configured to provide digital night vision, such as when using a near-infrared (NIR) illuminator and optionally thermal sensors. With the addition of an NIR illuminator, the scope 102 or 302 with a CMOS image sensor 722 may be configured to detect and identify in low-light or night-time conditions.

In some embodiments, a single aperture may be used for digital, direct-view, and LRF light. In other embodiments, one of the apertures 126 or 122 may be used or an additional aperture may be provided for a thermal camera objective, which can be added to the architecture for day and night thermal vision capabilities. The thermal objective may be schematically similar to the day digital optical path shown with a 640×512 pixel uncooled vanadium oxide microbolometer (8-14 μm spectral range) and germanium lenses. Other embodiments are also possible.

It should be appreciated that, instead of a switchable microdisplay 726, a sensor may be switched into and out of the light path. Alternatively, an electrically controllable mirror may be switched into or out of the light path. Other embodiments are also possible.

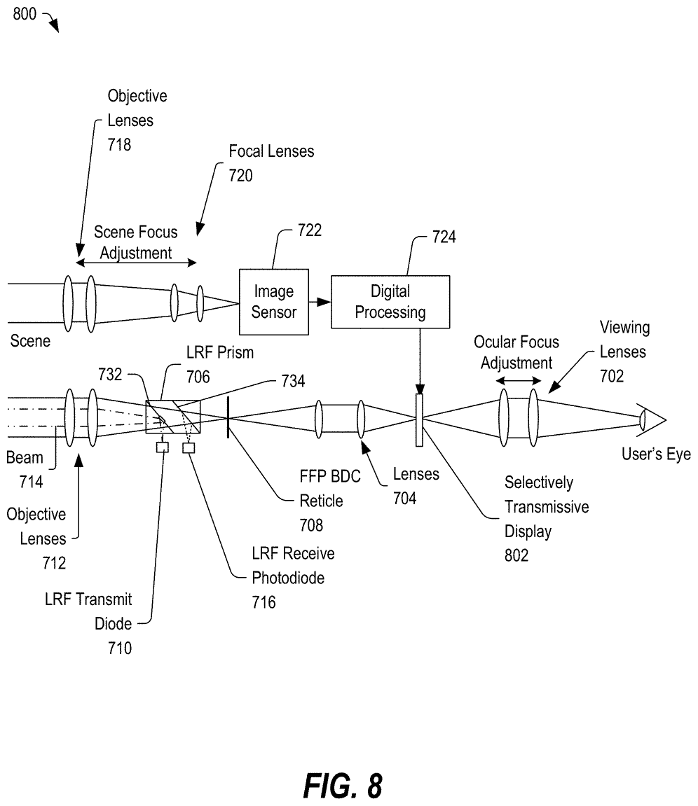

FIG. 8 depicts a diagram 800 of components of a scope 102 of FIGS. 1A-2B including a selectively transmissive microdisplay 802, in accordance with certain embodiments of the present disclosure. In this example, the diagram 800 may include all of the elements of the scope 102 of FIG. 7, except that the pivot 728 and the actuator 730 may be omitted. Further, the switchable microdisplay 726 may be replaced with a selectively transmissive display 802 positioned at the second focal plane and responsive to electrical signals from the digital processing circuitry 724 to allow direct-view light to pass through to the viewing lenses 702 or to present digital image data to the viewing lenses 702. Other embodiments are also possible.

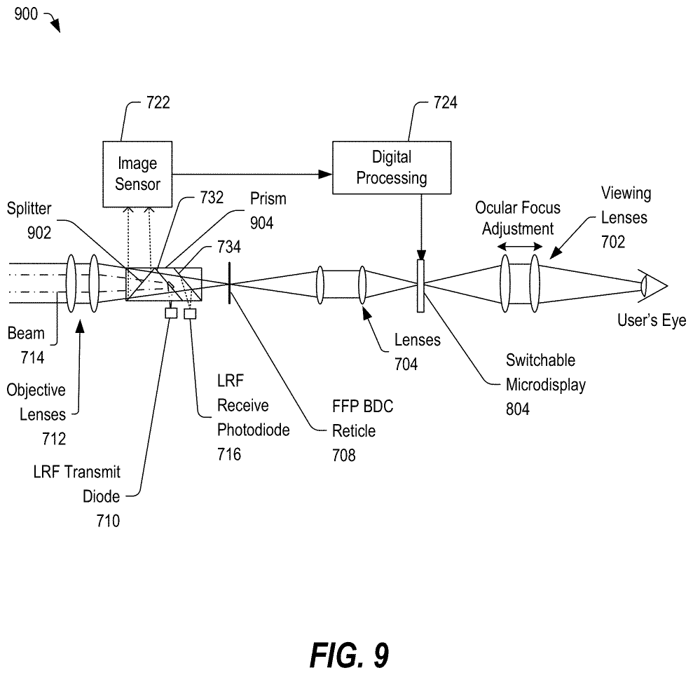

FIG. 9 depicts a diagram 900 of components of a scope 302 of FIG. 3 including a splitter 902 configured to direct light from the optical path toward a sensor circuit, in accordance with certain embodiments of the present disclosure. The scope 302 may include all of the elements of the scope 102 of FIG. 7 or 8, except that the lenses 718 and 720 may be omitted. Further, the LRF prism 406 may be replaced with a prism assembly 604 that includes splitters 732 and 734 and that further includes a splitter 902, which may direct a portion of the received light toward the image sensor 722.

In some embodiments, the splitter 902 may be configured to direct a portion of the light from the view area towards the image sensor 722 while also passing the remaining light from the view area to the viewing lens 702. In other embodiments, the splitter 902 may be configured to switch into and out of the light path to selectively divert at least a portion of the light toward the image sensor 722. In other embodiments, the splitter 902 may be electrically activated to selectively divert at least a portion of the light toward the image sensors 722. Other embodiments are also possible.

In this embodiment, the switchable microdisplay 804 may be implemented as a selectively transmissive display that can be electrically controlled to allow the direct-view light to be delivered to the viewing lenses 702 or to provide digital display data to the viewing lenses. Alternatively, the display may be actuated into and out of the second focal plane to provide the image data to the viewing lens. Other embodiments are also possible.

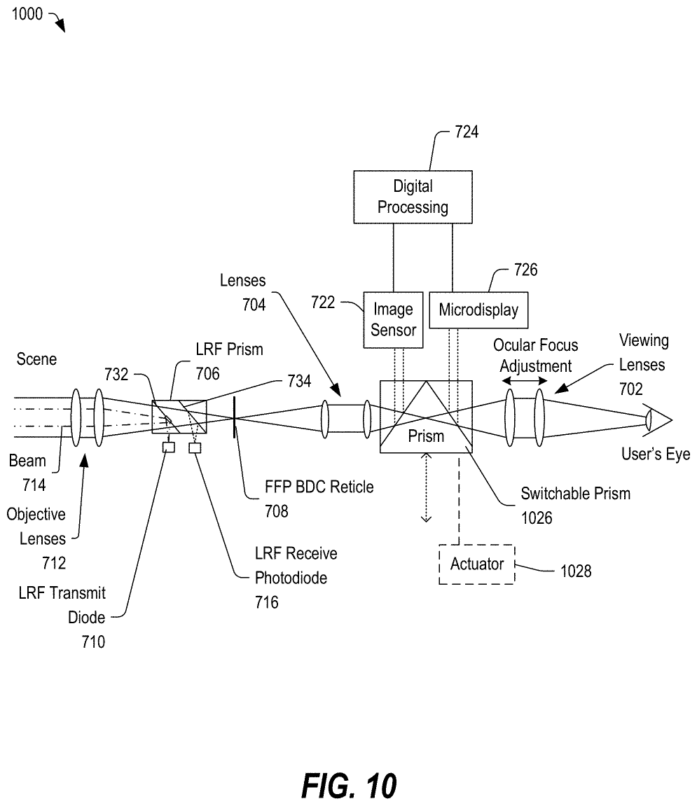

FIG. 10 depicts a diagram of components of a scope 1000 of FIGS. 1A-3 including a switchable display element including a switchable prism 1026, in accordance with certain embodiments of the present disclosure. The scope 1000 may include most of the elements of the scope 700 of FIG. 7, except that the separate digital light path may be omitted, and the switchable prism 1026 may be provided. The switchable prism 1026 may be moved into and out of the light path to selectively direct a portion of the light toward one or more image sensors 722, which may be coupled to the digital processing circuit 724. The digital processing circuit 724 may provide image data to the microdisplay 726, which may provide the image data to the prism 1026 to direct the digital data toward the viewing lenses 702. Other embodiments are also possible.

In the above discussion of FIGS. 7-10, embodiments have been disclosed that have included a first direct-view light path from the objective lens to the viewing lens and a second digital-view light path to allow light to the image sensor. Further, embodiments have been shown that include a single light path from which a portion of the light can be diverted by a mirror or splitter to sensors for generating display data. It should be appreciated that the optical devices of FIGS. 1A-10 may be implemented with one or more light paths. In an example, in addition to the direct-view light path and the digital light path, the scope may include additional digital light paths by adding lenses and by including sensors responsive to other wavelength bands. In an example, one or more additional digital light paths may be included to provide, for example, a thermal path including associated thermal sensors. Additional sensor possibilities could include long-wavelength infrared (LWIR) sensors, short-wavelength infrared (SWIR) sensors, medium wavelength infrared (MWIR) sensors, or digital sensors that are optimized for low-light imaging. These multiple digital paths could be used individually or fused and displayed to the user. Further, the paths could be used individually or fused for the purposed of display and optionally for target acquisition, selection, tracking, and fire control. Other embodiments are also possible.

Alternatively, in some embodiments, splitters may be used that can include reflective surfaces that are reflective only within a particular frequency range, making it possible to divert light of different frequencies toward different sensors while allowing visible light to pass through to the viewing lenses. Other embodiments are also possible.

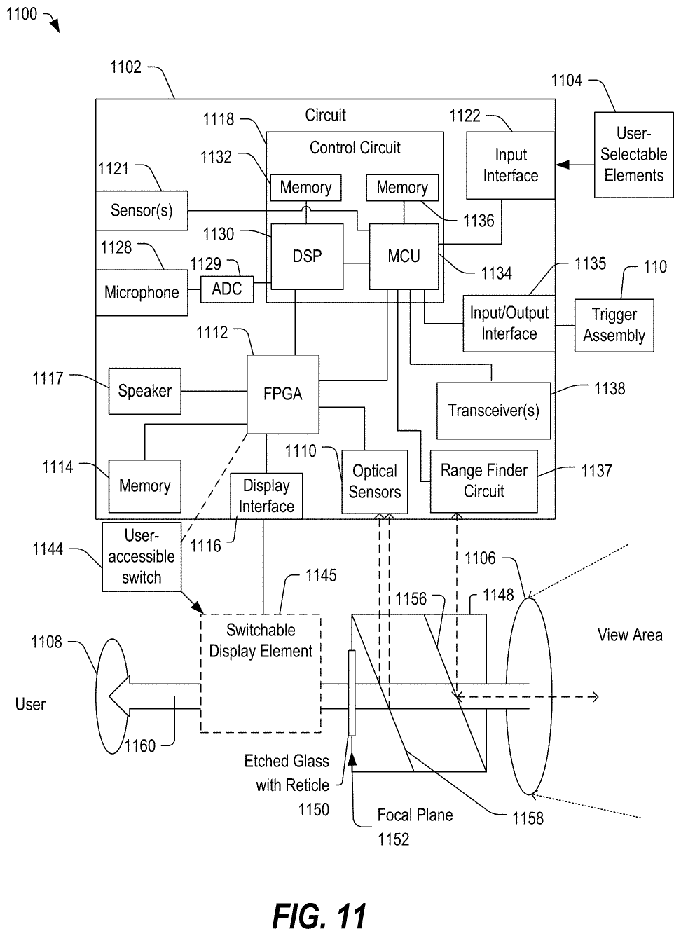

FIG. 11 depicts a block diagram of a scope 1100 of any of FIGS. 1A-10 including circuitry configured to control operation of the switchable circuit element, in accordance with certain embodiments of the present disclosure. In the illustrated example, a prism 1148 may be used to direct portions of the received light toward sensor circuitry and to allow a portion of the received light to pass through to a viewing lens 1108. In this example, the switchable display element 1145 is shown between the prism 1148 and the viewing lens 1108.

The scope 1100 includes a circuit 1102 coupled to one or more user-selectable elements 1104, such as buttons, levers, switches, rollers, other selectable elements, or any combination thereof. The circuit 1102 may also be coupled to a trigger assembly 110 of a firearm 104. Further, the circuit 1102 may be coupled to a user-accessible switch 1144, which may be coupled to a switchable display element 1145.

The scope 1100 may include one or more lenses including an objective lens 1106 configured to receive light from a view area including reflected light corresponding to a pulsed laser beam. The scope may further include a prism 1148 including a first splitter 1156 configured to direct reflected laser light toward a range finder circuit 1137. The prism 1148 may further include a second splitter 1158 configured to direct a portion of the received light toward one or more optical sensors 1110. The prism 1148 may further include etched glass with a reticle 1150 positioned at a first focal plane 1152. The scope 1100 may also include a switchable display element 1145 configured to selectively intersect a light path 1160 to a viewing lens 1108.

The circuit 1102 may include a field-programmable gate array (FPGA) 1112 including inputs coupled to the one or more optical sensors 1110, a memory 1114, a display interface 1116, and a speaker 1117. The FPGA 1112 may also be coupled to a control circuit 1118.

The control circuit 1118 may include a digital signal processor (DSP) 1130 coupled to a memory 1132 and configured to receive digital signals from a microphone 1128 via an analog-to-digital converter (ADC) 1129. The control circuit 1118 may also include a microcontroller unit 1134 coupled to a memory 1136 and to the DSP 1130. The MCU 1134 may also be coupled to one or more sensors 1121, an input interface 1122, an input/output interface 1135, one or more transceivers 1138, the range finder circuit 1137, and the FPGA 1112.

In some embodiments, the user-accessible switch 1144 may include a lever, a switch, or another feature accessible by the user to manually or mechanical switch the microdisplay into the light path 1160. In some embodiments, the user-accessible switch 1144 may cause the circuit 1102 to control an actuator (such as actuator 730 in FIG. 7, which may be coupled to the control circuit 1102) to move the switchable display element 1145 into the light path 1160. The switchable display element 1145 may include pivotable displays, pivotable mirrors, translatable displays, translatable mirrors, movable prisms, electrically controllable displays, electrically controllable mirrors or prisms, or any combination thereof. Other embodiments are also possible.

The scope 1100 of FIG. 11 may be configured to enable a direct-view mode without fire control, a direct-view mode with fire control, a digital-view mode without fire control, a digital-view mode with fire control, or any combination thereof. In some embodiments, integration of the scope 102 (or 302) including the fire control system with the trigger assembly of the firearm 104 (or 304) may reduce the overall size and weight of the firearm system.

In an alternative embodiment, instead of switching the display element 1145 into the light path, a mirror or prism may be switched into the light path to direct light from a stationary display element toward the viewing lens 1108. In still another embodiment, the prism 1148 may be omitted and one or more of the optical sensors 1110 may be switched into and out of the light path. Other embodiments are also possible.

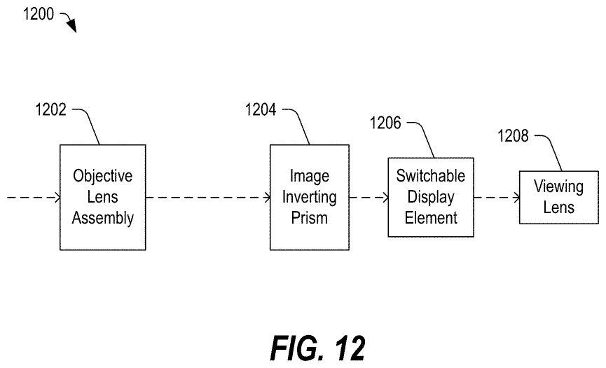

FIG. 12 depicts a block diagram of components of a scope 1200 including an image inverting prism 1204 and a switchable display element 1208 in accordance with certain embodiments of the present disclosure. The scope 1200 may include an objective lens assembly 1202 configured to capture light from a view area and focus the light toward an image inverting prism 1204, which may be configured to rotate an image by 180 degrees. The image inverting prism 1204 may direct the rotated light toward a viewing lens 1208. The image inverting prism 1204 may be one of many prism types designed to rotate the image 180 degrees and output the image in-line with the input. Some possible prism types include a Dove prism, Abbe prism, Pechan prism, and a Pechan-Schmidt prism. Other prism designs are possible.

The scope 1200 may include a switchable display element 1206, which may include any of the above-described translatable, pivotable, or electrically controllable microdisplays, mirrors, prisms, optical sensors, or any combination thereof. The switchable display element 1206 allows the user to selectively switch between a direct-view mode and a digital display mode.

The scope 1200 may be shorter and smaller than a conventional rifle scope because the scope 1200 may be implemented with a single focal plane. The image inverting prism 1204 can be configured to invert the captured light so that some of the lenses can be omitted, making it possible to produce a smaller, lighter optical device.

To keep the size of the optical device small, the battery power may be integrated into the stock 106 or 306 of the firearm 104 or 304. By moving the batteries 116 to the stock 106 or 306, the size and weight of the housing of the scope 102 or 302 may be reduced, and a portion of the overall weight can be distributed to the stock 106 (or 306) for an improved center of gravity and improved balance. Further, moving the batteries 116 to the stock 106 may enable the inclusion of a powered data rail or connection system for the addition of other modular add-on units.

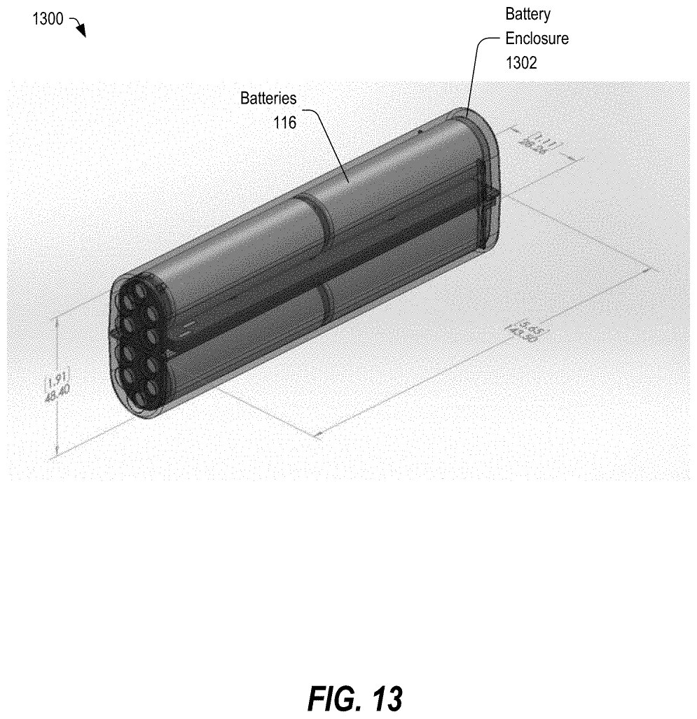

FIG. 13 depicts an isometric view of a battery pack 1300 that can be incorporated within the firearm 104 of FIGS. 1A-3, within the scope of FIGS. 3-12, or any combination thereof. The battery pack 1300 may include a battery enclosure 1302 configured to encase or otherwise secure a plurality of batteries 116. The battery pack 1300 may be installed in the stock 106 of the firearm 104 or 304.

In some embodiments, the battery pack 1300 may be implemented as a smart battery pack that including four rechargeable lithium-ion cells with onboard protection circuits. Further, the battery pack 1300 can include a fuel gauge and one or more microcontrollers. It should be appreciated that the smart battery pack implementation with four rechargeable lithium-ion cells represents one possible option for a standardized system battery pack. Other embodiments are also possible.

In some embodiments, the battery pack 1300 may be approximately 5.65 inches long, 1.91 inches wide, and 1.11 inches tall, and may weigh approximately 0.60 pounds. In some embodiments, the battery capacity may be approximately 3,500 mAh that can provide up to 50 Watt-hours of energy. Other embodiments are also possible.

In some embodiments, the batteries 116 individually or the battery pack 1300 as a whole may have the capability to contain a crypto-key. In some embodiments, the circuit 1102 may be configured to operate only with a battery pack 1300 that has a valid crypto-key. In a particular embodiment, an electronic device may be configured to authenticate the battery chargers, the chargers may be configured to authenticate the batteries, and the batteries may be configured to authenticate the fire control system. Other embodiments are also possible.

The systems, apparatuses and methods described above with respect to FIGS. 1-13 may include a firearm system including a firearm and a scope coupled to the firearm. The scope may be mechanically coupled to the firearm and electrically coupled to a circuit of a trigger assembly to selectively control timing of discharge of the firearm.

In some embodiments, the firearm system may include an integrated fire control system. Precision fire control modes may utilize an electromechanical (EM) trigger mechanism that may include mechanical components, such as a trigger shoe and associated mechanical components as well as a trigger circuit, which may be controlled by a control circuit within the scope to selectively control timing of discharge of the firearm until the aim point of the firearm is aligned to a selected target.

In some embodiments, user-selectable elements or controls may be located in ergonomic locations on the firearm, such as on or adjacent to a trigger guard, on a housing of the scope, in other locations, or any combination thereof.

In some embodiments, the direct-view optical path can include a fixed 4× magnification objective and a ballistic drop compensating (BDC) reticle. Zeroing of the entire fire control system can be accomplished through windage and elevation adjustment mechanisms in the base of the scope. The direct-view path can be a primary optical path for general scouting or “glassing”. During this time, all the electronics can be operating in a low-power or “sleep” state.

User-interaction with a switch on the side of the scope (or on the firearm) may cause the scope to enter digital-view mode. In the digital-view mode, the scope may provide a number of functions, including laser rangefinder, ballistics calculation, and wireless networking functionality. The wake-up time from a low-power state to the full-power digital mode may be configured to be less than 500 milliseconds.

In digital mode, the shooter will see a displayed reticle corresponding to the 100-yard zero of the firearm. To gather a firing solution for a target at any unknown range, the shooter may first range the target using a button, which may be located on the scope or on the trigger guard of the firearm. The shooter may align the reticle with the target and press and release the range button. Upon release of the button, the LRF of the optical scope may range objects corresponding to the aim point of the firearm. Within 250 milliseconds, the LRF circuit may determine the range and provide the range measurement data to the MCU, which may provide the range data to the FPGA for presentation with an adjusted reticle that is updated to the correct firing solution for that range. In addition to preconfigured ammunition and firearm parameters (projectile diameter, length, drag coefficient, barrel length, twist, muzzle velocity, height over bore, etc.), a ballistics calculator may also take into account the measurements from other sensors of the scope, including range to target, inclination angle, cant angle, shot direction, temperature, humidity, barometric pressure, and so on. In some embodiments, the user may provide a manual input corresponding to an estimate of the crosswind speed and direction, which may be input by interacting with a rocker button or pair of buttons on the scope. In other embodiments, laser scintillation-based wind measurement may be used to determine wind speed and direction. The ballistic solution may be determined based on a combination of parameters or factors, including bullet drop, spin drift, Magnus effect, Coriolis effect, aerodynamic jump, and so on.

In some embodiments, the reticle provided to the display may be updated in real-time, accounting for one or more parameters that may change between the time of ranging and the time that a shot is taken. The displayed reticle can persist through multiple shots, until the shooter ranges another target or cancels the current settings to return to the 100-yard zero reticle range. At all times, the scope may display the range that the reticle is currently set to and may display a secondary reticle to always indicate the 100-yard zero position. This allows for quick shots at point blank range without the need to do anything other than use the 100-yard reticle and squeeze the trigger.

In some embodiments, the scope can include a transceiver 1138 configured to transmit and receive data from external networks. In an example, the transceiver 1138 can live-stream the field of view of the scope, the heads-up display (HUD) with the reticle, and sensor information to a wireless network and optionally to other devices, directly or through the network. The other devices can include computers, phones, tablets, augmented reality glasses, other scopes, or any combination thereof. In a particular embodiment, the scope can operate as an 802.11G Wi-Fi hot spot and data as well as instructions can be sent and received via the transceiver 1138.

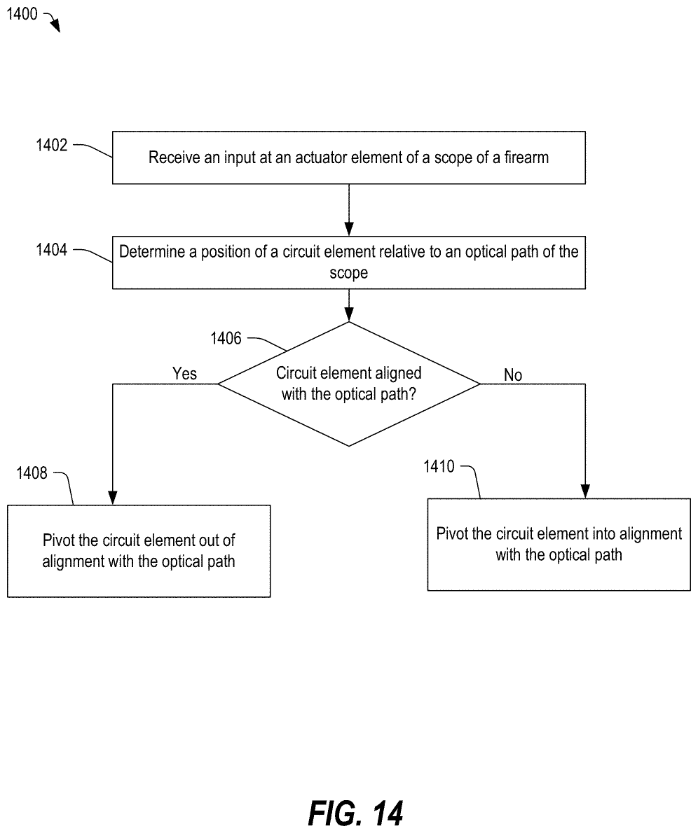

FIG. 14 depicts a flow diagram of a method 1400 of selectively actuating a display element into alignment with a light path, in accordance with certain embodiments of the present disclosure. The method 1400 may include receiving an input at an actuator element of a scope of a firearm, at 1402. The input may be received from a lever, a switch, or another manual input, or may be received from a control circuit in response, for example, to a user's interactions with a switch or lever.

At 1404, the method 1400 can include determining a position of the switchable circuit element relative to the optical path of the scope. If, at 1406, the switchable circuit element is aligned with the optical path, the method 1400 may include pivoting the switchable circuit element out of alignment with the optical path, at 1408. Otherwise, at 1406, if the switchable circuit element is not aligned with the optical path, the method 1400 can include pivoting the switchable circuit element into alignment with the optical path, at 1410. It should be appreciated that the switchable circuit element may include a display, a sensor, an electrically controllable mirror or prism, another component, or any combination thereof.

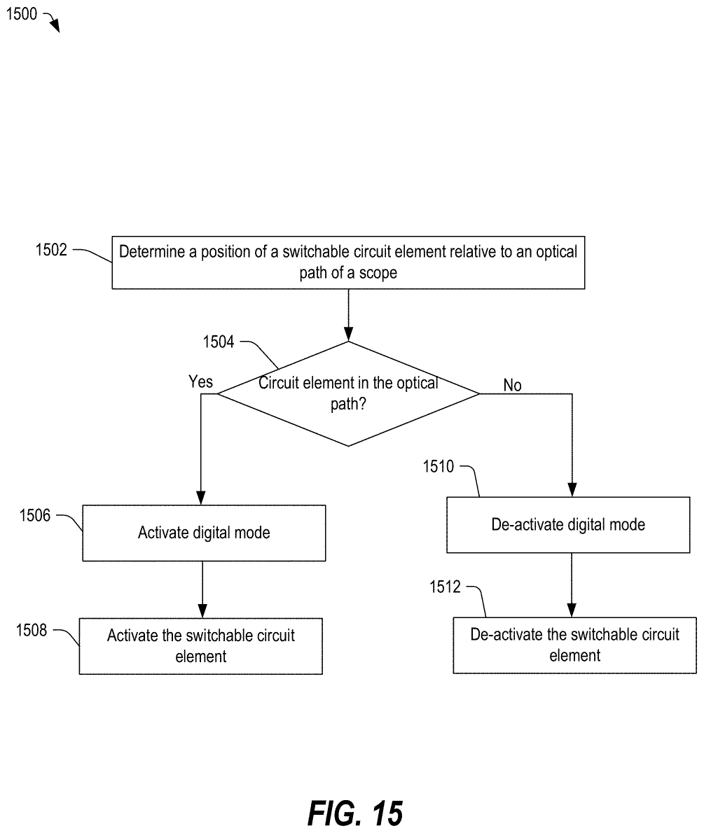

FIG. 15 depicts a flow diagram of a method 1500 of selectively controlling a display, in accordance with certain embodiments of the present disclosure. At 1502, the method 1500 may include determining the position of a switchable circuit element relative to the optical path of the scope. The position may be determined by a magnetic or optical encoder or by mechanical, optical, or magnetic switches, or any combination thereof.

At 1504, if the switchable circuit element is in the optical path, the digital mode of the scope is activated, at 1506, and the switchable circuit element is also activated, at 1508. Otherwise, at 1504, if the switchable circuit element is out of the optical path, the method 1500 may include deactivating and digital mode, at 1510, and entering a low-power state including deactivation the switchable circuit element, at 1512.

It should be appreciated that the methods 1400 and 1500 of FIGS. 14 and 15 include determining a position of the switchable circuit element or determining an operating mode of the scope. However, in other embodiments, rather than toggling from a current state to another state, the position may be established by moving the lever or the switch in one direction to position the switchable element in the optical path and in the other direct to position the switchable element out of the optical path.

In another embodiment, the user may interact with one or more user-selectable elements on the scope or on the firearm to adjust the operating mode of the scope between a first (direct-view) mode, a second (direct-view with fire control) mode, a third (digital-view with fire control) mode, and a fourth (digital-view without fire control) mode. Other operating modes are also possible.

In conjunction with the systems, apparatuses, and methods described above with respect to FIGS. 1A-15, a firearm system may include a firearm coupled to a scope that includes a direct-view mode in which a DVO assembly directs and focuses light from a view area toward a view lens of the scope. The scope may further include digital circuitry including a switchable circuit element that can be configured to selectively interrupt the optical light path. In an example where the switchable circuit element is a sensor, the switchable circuit element may be switched into the light path to capture optical data. In an example where the switchable circuit element is a microdisplay element, the microdisplay element may selectively interrupt the second focal plane by pivoting into the second focal plane via user-selection of a lever or button or via a control signal provided to an actuator. Alternatively, the microdisplay element may selectively interrupt the second focal plane by transitioning from a fully transmissive (transparent) state to a digital-display state in which digital data is provided that is perceptible through the viewing lens of the scope. Other embodiments are also possible.

In some embodiments, the firearm may include a trigger assembly including mechanical components as well as electronic circuitry. The scope may include control circuitry coupled to the electronic circuitry of the trigger assembly. In some embodiments, the scope may be configured to operate in a direct-view mode in which a direct view of a view area of the scope is presented to the viewing lens of the scope through a DVO assembly. In a digital-view mode, the scope may be configured to present a digital display to the viewing lens of the scope. In a fire control mode, whether in the digital-view mode or the direct-view mode, the scope may control timing of the discharge of the firearm to prevent discharge until the aim point corresponds to a ballistic solution of a selected target based on LRF data, sensor data, such as incline, direction, temperature, barometric pressure, other sensor data, or any combination thereof.

Although the present invention has been described with reference to preferred embodiments, workers skilled in the art will recognize that changes may be made in form and detail without departing from the scope of the invention.

What is claimed is:

1. An optical scope comprising:
a direct-view optics assembly including an objective lens and a viewing lens, the direct-view optics assembly configured to direct and focus light from a view area received by the objective lens toward the viewing lens;
a selectable element accessible by a user to select one of a direct-view mode and a digital-view mode; and
a switchable circuit element configured to selectively interrupt a light path between the objective lens and the viewing lens in response to selection of the digital-view mode.

2. The optical scope of claim 1, wherein the switchable circuit element includes a microdisplay.

3. The optical scope of claim 1, wherein the switchable circuit element includes an optical sensor.

4. The optical scope of claim 1, wherein the switchable circuit element is configured to pivot about a pivot point between a first position outside of the light path and a second position that interrupts the light path in response to selection of the digital-view mode.

5. The optical scope of claim 1, wherein the switchable circuit element is configured to translate between a first position outside of the light path and a second position that interrupts the light path in response to selection of the digital-view mode.

6. The optical scope of claim 1, wherein the optical scope further includes:
an actuator coupled to the switchable circuit element and configured to move the switchable circuit element between a first position outside of the light path and a second position that interrupts the light path; and
a control circuit coupled to the actuator and configured to provide signals to the actuator to control movement of the switchable circuit element.

7. The optical scope of claim 1, wherein the switchable circuit element is transmissive to light in a first mode and interrupts at least a portion of the light path in a second mode to display image data.

8. The optical scope of claim 1, further comprising circuitry that, in the digital-view mode, is configured to provide at least one of a zoom functionality, a target acquisition functionality, a target tracking functionality, and a range finding functionality.

9. The optical scope of claim 1, wherein the switchable circuit element comprises:
a microdisplay that is stationary; and
a movable element configured to move into and out of the light path and configured to direct light from the microdisplay toward the viewing lens.

10. The optical scope of claim 1, wherein the switchable circuit element comprises:
a sensor that is stationary; and
a movable element configured to move into and out of the light path and configured to direct light from the objective lens toward the sensor.

11. The optical scope of claim 1, further comprising a plurality of sensors including at least one infrared sensor configured to capture infrared data associated with the view area.

12. A method comprising:
in a first mode, providing light received from a view area at an objective lens of an optical scope through a first focal plane including a reticle along an optical path to a viewing lens of the optical scope;
receiving a user input corresponding to a mode selection;
transitioning from the first mode to the second mode in response to receiving the input; and
in the second mode, coupling a switchable circuit element into the optical path to provide a digital-view of the view area.

13. The method of claim 11, wherein coupling the switchable circuit element comprises selectively activating a microdisplay element within the optical path to transition from a transmissive state to an active state.

14. The method of claim 11, wherein coupling the switchable circuit element comprises moving one of a microdisplay and a mirror element into the optical path to direct image data from the microdisplay toward the viewing lens.

15. The method of claim 14, wherein moving one of the microdisplay and the mirror element comprises moving the one of the microdisplay and the mirror element about a pivot.

16. The method of claim 14, wherein moving one of the microdisplay and the mirror element comprises translating the one of the microdisplay and the mirror element from a first position to a second position.

17. The method of claim 11, wherein coupling the switchable display element comprises applying an electrical signal to one of a mirror, a prism, and a display element to alter a reflectivity of a surface to interrupt the optical path.

18. The method of claim 11, wherein coupling the switchable circuit element comprises moving an optical sensor into the optical path to capture optical data associated with the view area.

19. A system comprising:
an optical scope including:
a selectable element accessible by a user to switch between a direct-view mode and a digital-view mode;
a direct-view optics assembly including an objective lens and a viewing lens, the direct-view optics assembly configured to receive light from a view area via the objective lens and to direct and focus the light toward the viewing lens in the direct-view mode; and
a switchable circuit element configured to selectively interrupt a light path between the objective lens and the viewing lens in the digital-view mode.

20. The system of claim 19, wherein the switchable circuit element includes at least one of a sensor, a mirror, and a microdisplay.

21. The system of claim 19, wherein the switchable circuit element is configured to pivot about a pivot point to selectively interrupt the light path.

22. The system of claim 19, wherein the switchable circuit element is configured to translate from a first position to a second position along a path to selectively interrupt the light path.
